(19) United States
(12) Patent Application Publication
(10) Pub. No.: US 2010/0251094 A1
(43) Pub. Date: Sep. 30, 2010

(54) METHOD AND APPARATUS FOR PROVIDING COMMENTS DURING CONTENT RENDERING

(75) Inventors: Jukka A. Holm, Tampere (FI); Antti Eronen, Tampere (FI); Juha Arrasvuori, Tampere (FI)

Correspondence Address: DITTHAVONG MORI & STEINER, P.C., 918 Prince Street, Alexandria, VA, 22314, US

(73) Assignee: Nokia Corporation, Helsinki (FI)

(21) Appl. No.: 12/412,617

(22) Filed: Mar. 27, 2009

(51) Int. Cl. G06F 17/00

(52) U.S. Cl. 715/230

(57) ABSTRACT

An approach is provided for selecting comments to present when rendering content such as music, images, video, games and other digital media. The approach includes determining a preference of a user for types of expressions presented as comments. Content received for rendering on a device of the user is determined. A comment about the content, based on the preference of the user, is automatically presented on the device in response to the content being received for rendering. In some embodiments an entity is determined to which the comment is attributed, and an identifier for the entity, such as an avatar, is also presented on the device when the content is being rendered to represent that the identified entity is providing the comment. In various embodiments, the entity is a default commentator, a celebrity or a contact of the user.

### BACKGROUND

The use of wireless, mobile communication devices has become pervasive, and is rapidly overtaking the use of traditional wired devices. As users' mobility increases, there is an increasing demand for the mobile devices to render a user's favorite content, such as songs, video and games. At the same time, there is growing interest in and demand for using networks to provide and maintain social contact among groups of users with some affinity, whether by family, friendship, work or some other relationship. Device and service providers who offer applications that cater to several of these many demands can enjoy a competitive advantage over other service providers.

### SOME EXAMPLE EMBODIMENTS

Therefore, there is a need for applications that can combine content rendering and social contact in the same application, whether the rendering device is mobile or not.

According to one embodiment, a computer-readable storage medium carries instructions which, when executed by a processor, cause an apparatus to perform at least determining a preference of a user for types of expressions presented as comments. Content received for rendering on the apparatus or another apparatus of the user is determined. Presentation on the apparatus of a comment about the content, based on the preference of the user, is automatically initiated before, during or after the content is rendered.

In some embodiments, an entity is determined to which the comment is attributed, and an identifier for the entity, such as an avatar, is also presented on the apparatus as part of the comment when the content is being rendered, to represent that the identified entity is providing the comment. In various embodiments, the entity is a default commentator, a celebrity or a contact of the user.

According to another embodiment, an apparatus comprises a processor and a memory storing executable instructions that (1) as part of execution or as a result of execution at least or (2) as both part of execution and as a result of execution at least cause the apparatus to determine a preference of a user for types of expressions presented as comments. Content received for rendering on the apparatus or another apparatus of the user is determined. Presentation of a comment about the content, based on the preference of the user, is automatically initiated on the apparatus when the content is being rendered.

According to another embodiment, an apparatus comprises means for determining a preference of a user for types of expressions presented as comments. The apparatus also comprises means for determining content received for rendering on the apparatus or another apparatus of the user. The apparatus further comprises means for automatically initiating presentation on the apparatus of a comment about the content, based on the preference of the user, when the content is being rendered.

According to another embodiment, a method comprises providing access to receive, from a device, data indicating content being rendered on the device in response to input from a user and data indicating the user's preference for types of expressions presented as comments. In response to receiving the data indicating the content, a comment based on the user's preference is transferred to be presented on the device while the content is being rendered.

According to yet another embodiment, an apparatus comprises means for providing access to receive, from a device, data indicating content being rendered on the device in response to input from a user and data indicating the user's preference for types of expressions presented as comments. In response to receiving the data indicating the content, a comment based on the user's preference is transferred to be presented on the device while the content is being rendered.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings, in which:

FIG. 1A is a diagram of a system for providing comments during content rendering, according to one embodiment;

FIG. 1B is a diagram of an example presentation of a comment, according to one embodiment;

FIG. 1C is a diagram of an example presentation of a different comment, according to one embodiment;

FIG. 2 is a diagram of components of comment modules, according to one embodiment;

FIG. 3A is a diagram of a record in a social user profile data structure, according to one embodiment;

FIG. 3B is a diagram of a record in a playlist data structure, according to one embodiment;

FIG. 3C is a diagram of a record in a comment data structure, according to one embodiment;

FIG. 4 is diagram of a comment presentation on a mobile terminal, according to one embodiment;

FIG. 5 is a flowchart of a comment process, according to one embodiment;

FIG. 6 is a flowchart of a comment process on a local device, according to one embodiment;

FIG. 7 is a flowchart of a comment process on a remote service, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a terminal that can be used to implement an embodiment of the invention.

### DETAILED DESCRIPTION OF EXAMPLE EMBODIMENTS

A method, apparatus, and software are disclosed for providing comments during content rendering. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to a single comment presented as text and graphic during the playing of a song on a mobile terminal connected to a network, embodiments of the invention are not limited to this context. It is explicitly anticipated that one or more comments are presented as text or images or video or sound before during or after any digital content selected by a user is rendered on a local mobile or wired device while the device has access to a network (i.e., is online) or not (i.e., is offline).

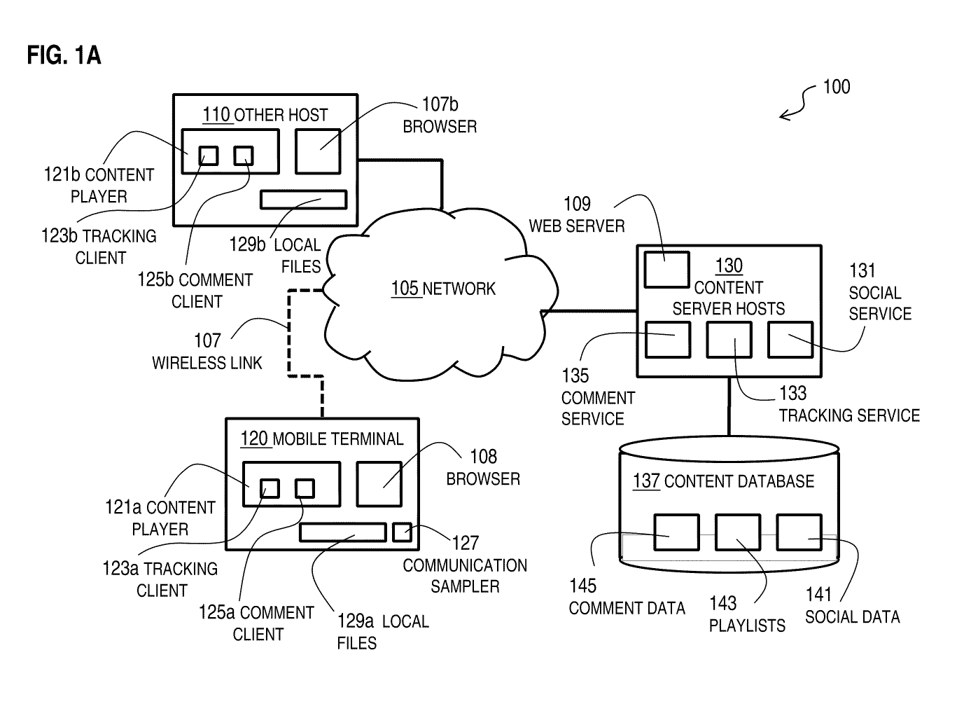

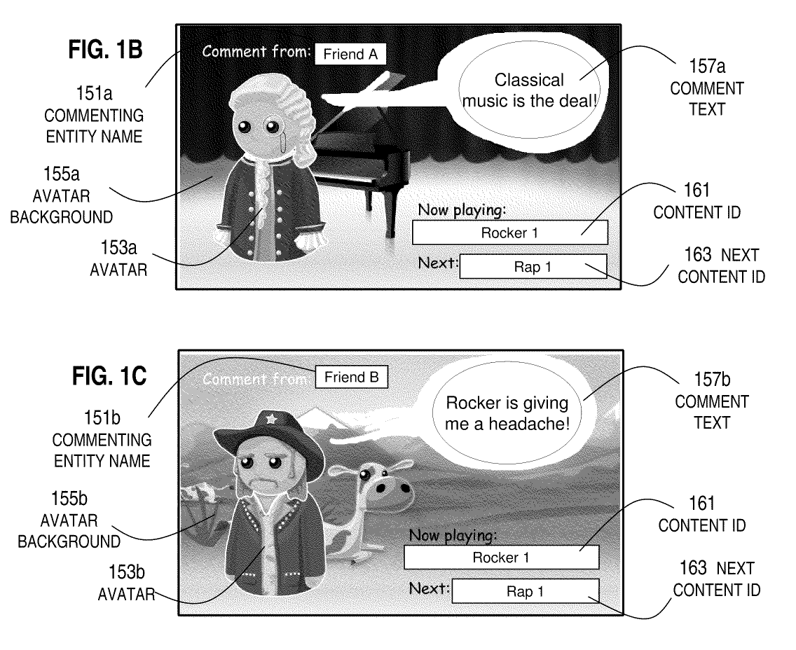

FIG. 1A is a diagram of a system 100 for providing comments during content rendering, according to one embodiment. The system 100 includes a communications network 105, and network nodes that include mobile terminal 120, content server hosts 130 and other host 110. Each of the nodes 110, 120, and 130 utilizes a rendering module to present content to a user. In many illustrated embodiments, a media or content player is an example of a rendering module. As used herein, content or media includes, for example, digital sound, songs, digital images, digital games, digital maps, point of interest information, digital videos (such as music videos, news clips and theatrical videos), advertisements, program files or objects, any other digital media or content, or any combination thereof. The term rendering indicates any method for presenting the content to a human user, including playing music through speakers, displaying images on a screen or in a projection or on tangible media such as photographic or plain paper, showing videos on a suitable display device with sound, graphing game or map data, music or video playback or streaming, games playing, image or map displaying, radio or television content broadcasting or streaming, or any other term of art for presentation, or any combination thereof.

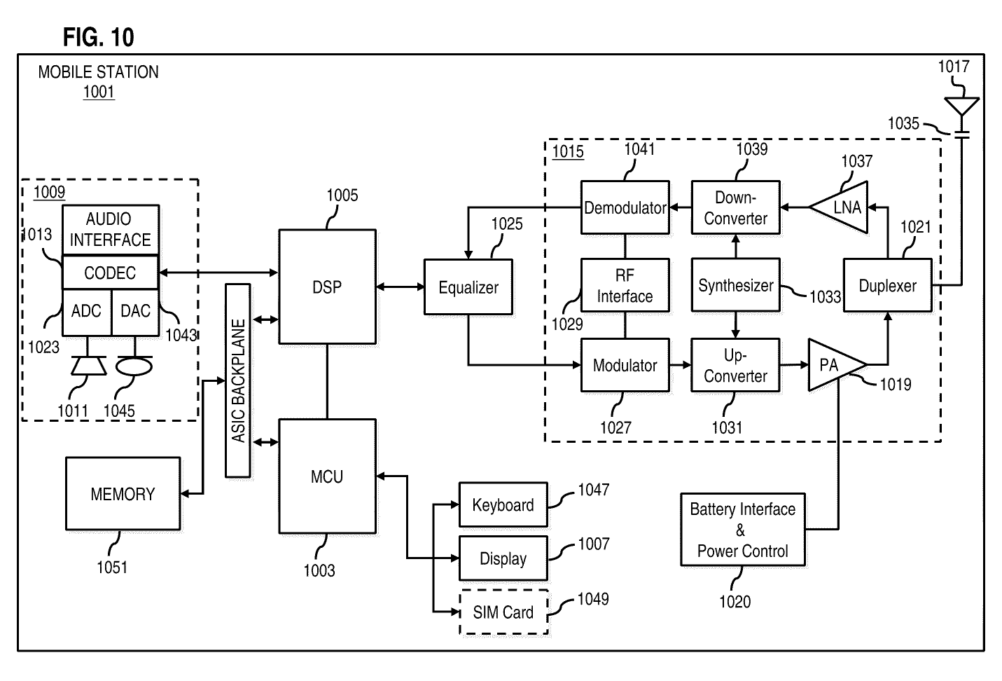

In various embodiments, nodes 110, 120, 130 can be any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, audio/video players, digital cameras/camcorders, televisions, digital video recorders, game devices, positioning devices, rack-mounted computers or computer blade systems or any combination thereof. Moreover, the nodes may have a hard-wired energy source (e.g., a plug-in power adapter), a limited energy source (e.g., a battery), or both. It is further contemplated that the nodes 110, 120, 130 can support any type of interface to the user (such as “wearable” circuitry, etc.). In the illustrated embodiment, node 120 is a wireless mobile terminal (also called a mobile station and described in more detail below with reference to FIG. 10). The mobile terminal 120 is connected to network 105 by a wireless link 107. The content server hosts 130 are in communication with a content database 137 that resides on storage media in one or more nodes, including one or more nodes in network 105.

By way of example, the communication network 105 of system 100 can include one or more wired and/or wireless networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network, or any combination thereof. In addition, the wireless network may be, for example, a cellular network and may employ various technologies including code division multiple access (CDMA), wideband—code division multiple access (WCDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process can be divided up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages. In the illustrated embodiment, mobile terminal 120 and other host 110 include browser 108 and browser 107b, respectively; and hosts 130 include web server 109.

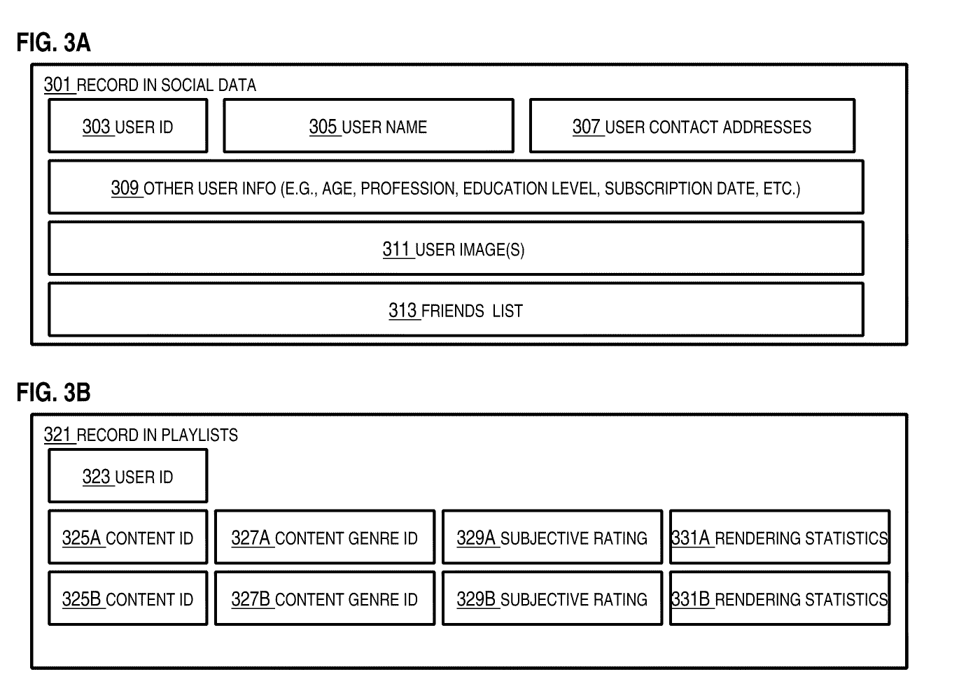

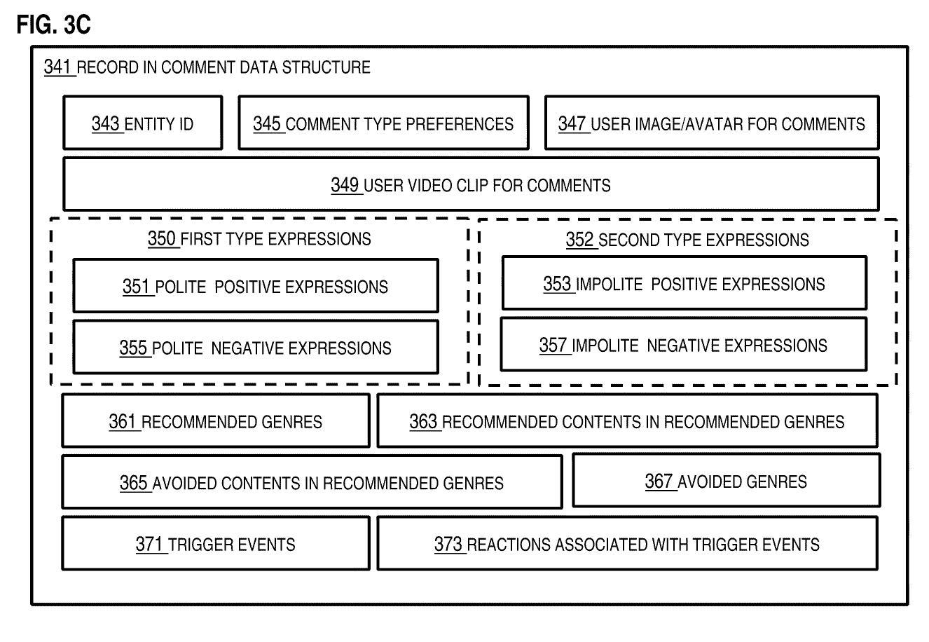

As depicted in FIG. 1A, one or more content server hosts 130 include web server 109, social service 131, content tracking service 133 and comment service 135. The content server hosts may be in different locations in or connected to network 105. The web server 109 is described above. Social service 131 provides services related to a social network of registered users of network 105, whereby one user is related to one or more groups of other users, e.g., by work, family, friendship or some other affinity. In the illustrated embodiments, the social service is related to the rendering of content, such as groups who share music or videos or games or other digital content, and is called a social content service. Social data indicating the users and their relationships are stored in social data structure 141 in content database 137. Social data structure 141 is described in more detail below with reference to FIG. 3A.

Tracking service 133 provides services related to tracking content rendered by registered users of the social service 131. LAST.FM™ service is an example of this kind of service which collects and maintains data about what music a user listens to, builds a music profile, and then provides personalized recommendations based on this profile. NOKIA SOCIAL MUSIC™ is an example of an emerging social music tracking service that not only tracks music rendered by a user but supports the easy sharing of playlists among users. User playlists indicating the content rendered by each user are stored in playlists data structure 143 in content database 137. Playlist data structure 143 is described in more detail below with reference to FIG. 3B. A playlist is information about content rendered on one or more players in response to input by a user, and is associated with that user. A play history is information about the time sequence of content rendered on one or more players in response to input by a user, and is associated with that user.

According to some embodiments of the invention, the comment service 135 provides services related to generating, storing, selecting or presenting one or more comments to a user when the content is being rendered by that user on a local node, e.g., mobile terminal 120 or other host 110, such as just before, during or just after the content is rendered. In the illustrated embodiments, each comment indicates a positive or negative evaluation of the content being rendered. However, in other embodiments the comments can convey more neutral information about the content, such as a suggestion of similar content, personal memories associated with the content, historical context or other metadata for the content, such as the year the content was released, remakes or covers by other artists. In many embodiments, a comment is associated with another user related by one or more social networks to the user rendering the content on a local node, or other entities, such as celebrities and one or more default commentators. Comment data indicating comments associated with one or more entities are stored in comment data structure 145 in content database 137. Comment data structure 145 is described in more detail below with reference to FIG. 3C.

FIG. 1B is a diagram of an example presentation of a comment, according to one embodiment. The presented comment includes an area where there is presented a content identifier (ID) field 161 and an optional next content ID field 163. The presented comment also includes areas for presenting a commenting entity name 151a, an avatar 153a, an avatar background 155a, and a comment text 157a. FIG. 1B illustrates that when a user plays current music identified by the name “Rocker 1” in content ID field 161 and queues music identified by “Rap 1” in next content ID field 163, the system generates a comment from a social contact “Friend A” with different musical taste compared to the user or to the played or queued misc. It is assumed for purposes of illustration that Friend A favors classical music. Thus the avatar 153a and included background 155a indicate a classical setting. The comment text 157a indicates a polite positive comment “Classical music is the deal!” using a slightly idiosyncratic expressions associated with the commenting entity Friend A.

FIG. 1C is a diagram of an example presentation of a different comment; according to one embodiment. The presented comment includes an area where is presented the content identifier (ID) field 161 and the next content ID field 163 (which is optional), as in FIG. 1B. The presented comment also includes areas for presenting a different commenting entity name 151b, with a different avatar 153ba and a different avatar background 155b. This entity causes different comment text 157b to be presented. FIG. 1C illustrates that when the user next plays current music identified by the name “Rocker 1” in content ID field 161 and queues music identified by “Rap 1” in next content ID field 163, the system generates a different comment from a different social contact “Friend B” also with different musical taste from the user, playing content and next content. It is assumed for purposes of illustration that Friend B likes country music, especially that played by his own band. Thus the avatar 153b and included background 155b indicate a country setting. The comment text 157b indicates a polite negative comment “Rocker is giving me a headache!” using a generic expressions or an expression associated with the commenting entity Friend B. In some embodiments, the comment presentation is built as a web page in web server 109 and presented at the user's device in a web browser 107.

In the illustrated embodiment, each of mobile terminal 120 and other host 110 includes a content player 121a and 121b, respectively, collectively referenced hereinafter as content players 121. Content players 121 render content streamed to the node from another node (not shown) on network 105, or stored locally at or on the node, e.g., in local files 129a and 129b, respectively, collectively referenced hereinafter as local files 129. The content player 121a and content player 121b each includes a tracking client 123a and tracking client 123b, respectively, collectively referenced hereinafter as tracking client 123. The tracking client 123 reports data indicating the content rendered at a node and, in some embodiments, other context data, such as the time rendered, to a tracking service, e.g., tracking service 133 on content server hosts 130.

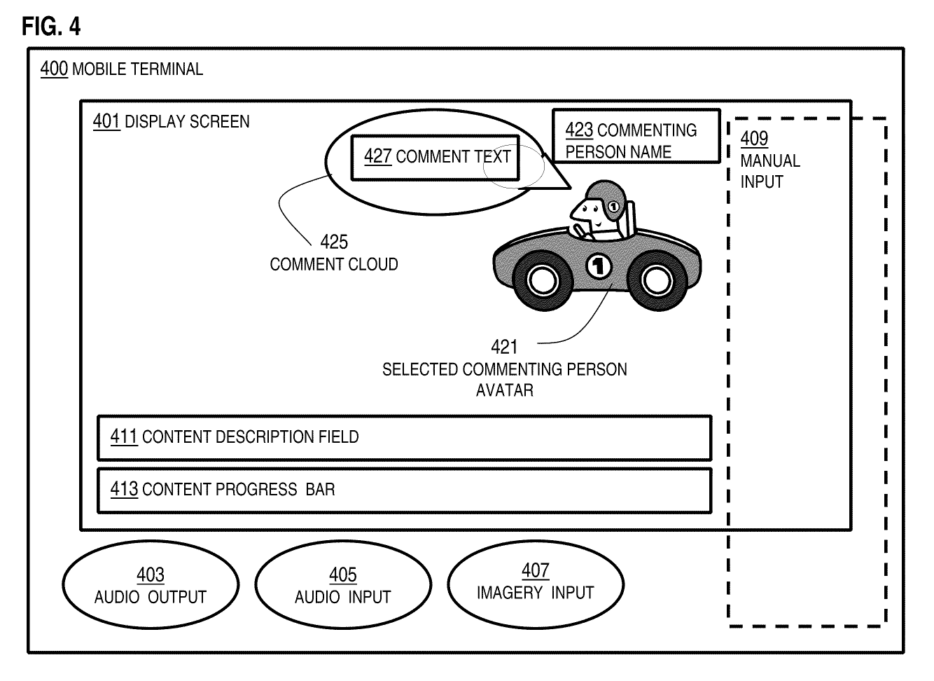

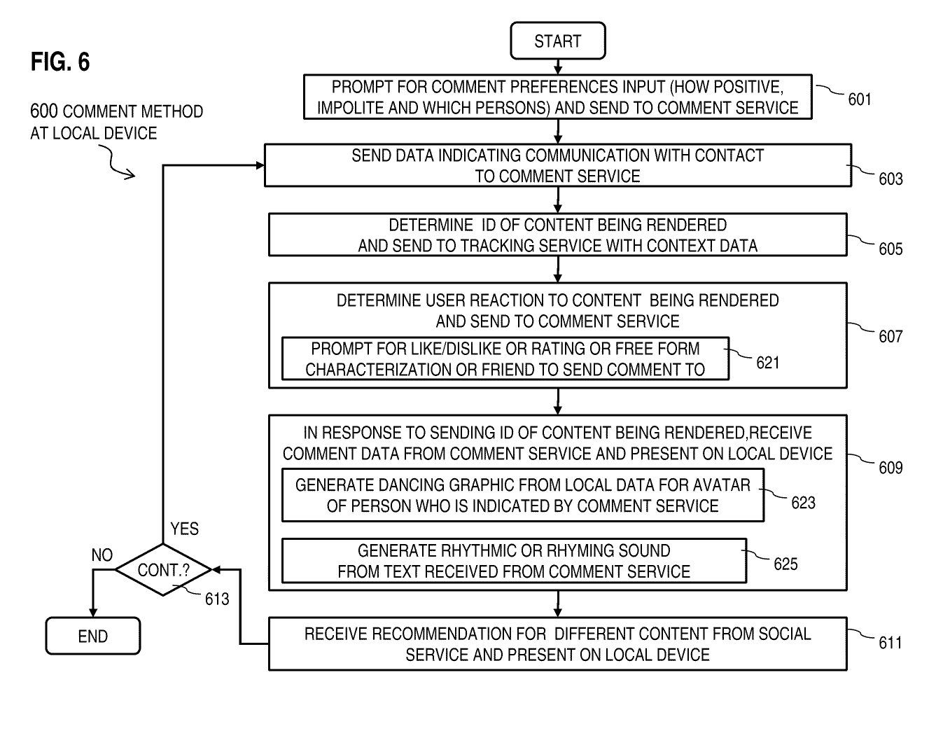

According to the illustrated embodiments, content player 121a and content player 121b include comment client 125a and content client 125b, respectively, collectively referenced hereinafter as comment client 125. Comment client 125 is described in more detail below with reference to FIG. 4 and FIG. 6. Comment client 125 communicates with a comment service, e.g., comment service 135 on content server hosts 130 to support the generation and presentation of comments, such as depicted in FIG. 1B and FIG. 1C.

In some embodiments, mobile terminal 120 includes a communication sampler process 127 that samples communications from the mobile terminal over wireless link 107, such as text messages, email, and voice communications, and sends the sampled data to comment service 135. In these embodiments, the comment service 135 analyzes the sampled data to determine positive, negative and neutral expressions, either generic or associated with a content or a content genre, to be associated with the user of mobile terminal 120, as described in more detail below.

Although a particular set of nodes, processes, and data structures are shown in FIG. 1A for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion. For example, in some embodiments, social service 131 includes a web server 109 to manage web pages used to pass information between social service 131 and on or more other nodes on network 105. In some embodiments, comment service 135 and comment data are included on a local host, e.g., mobile terminal 120 or other host 110. In some embodiments the communications sampler 127 is a process within the comment client 125.

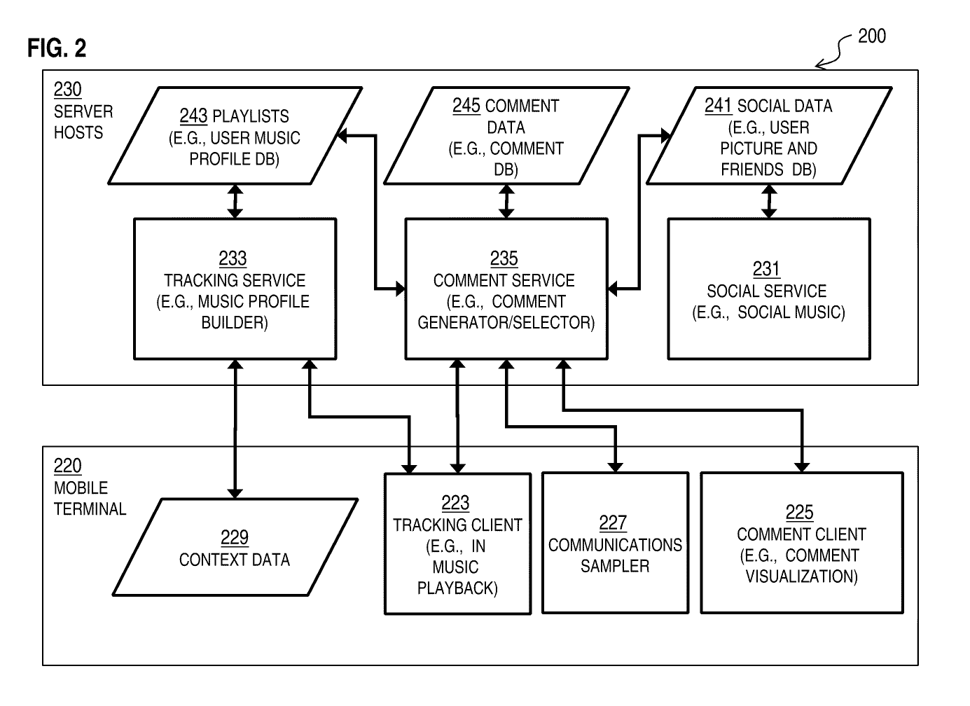

FIG. 2 is a diagram of components of social comment modules 200, according to one embodiment. The server host 230 (e.g., one or more of service hosts 130) includes a social service module 231, such as a social music module, a tracking service module 233, such as a music profile builder, and a comment service module 235, such as a music comment generator/selector. The social service module 231 maintains the social data 241, such as a database that includes a picture of a registered user and a list of other registered users who are friends of that user. The tracking service module 233 maintains the playlist data 243, such as a database that includes a list of music played by a registered user. In some embodiments the playlist includes data that indicates statistics of playing, e.g., how many times and how often each particular song or genre of music is played by the registered user. The comment service module 235 maintains the comment data 245, such as a comment database that includes a list of positive and negative terms of various types expressed by an entity.

In some embodiments, the comment includes data that indicates graphical elements of an avatar used to generate an image that represents the entity when a comment from that entity is presented to another user. By way of example, an avatar represents a graphical image having attributes of a user. That is, it is a software object representing a character. A software object is a collection of data values for parameters that describe the state of a thing along with computer instructions for one or more methods for presenting, transmitting or changing the state of that thing. The term “avatar” can also refer to the personality connected with the screen name, or handle, of an Internet user, including verbal expressions, poses and backgrounds.

The mobile terminal 220 (e.g., mobile terminal 120) includes a tracking client module 223 and a comment client 225, such as a music comment visualization module, and a communications sampler 227 (e.g., sampler process 127).

The mobile terminal 220 includes context data that indicates the state of the mobile terminal, such as the time and date, concurrently executing processes, available memory and available power on the mobile terminal, and communications at the mobile terminal, including contact addresses of one or more contacts with whom the user is communicating. In some embodiments, the mobile terminal may also sense and store other types of context information such as location based on the Global Positioning System (GPS) coordinates, illumination, temperature, acceleration, or background noise level, and any other sensory information that may be available in the future. Furthermore, in some embodiments the device may perform analysis of the sensory input, such as recorded audio signal, to determine e.g. the user's surroundings and context. For example, the terminal might analyze the microphone audio signal to determine that the user is in a car using known audio signal processing and pattern recognition methods. As another example, the terminal might determine based on the GPS location that the user is at home.

The mobile terminal 220 content player is used for content rendering, such as music playback. The mobile terminal 220 is used for displaying the comments on a screen of the mobile terminal, using any of several modules, such as a browser or the content player. In addition, the tracking client in the mobile content player logs information on content rendering (e.g., music file playback) and the user's context data 229, and this information is uploaded to the tracking service module 233 or comment service module 235 on server hosts 230, or both, and stored into the server's playlist database 243. The server tracking service module 233 learns music profiles for different users, and the server comment service module 235 stores comments related to music, and stores user pictures and avatars in the comment database 245. The communications sampler module 227 monitors other communications and sends samples to the comment service module 235 to determine expressions associated with the user of mobile terminal 220 or the communicating contacts. The server tracking service 233 monitors what music the client is currently playing, and the comment service 235 selects a suitable friend of other entity from the social data structure 241 and comments associated with the selected entity from the comment data structure 245, as described in more detail below. This information is passed to the comment client 225 and visualized on the mobile terminal.

In other embodiments, one or more modules depicted on one node of hosts 230 and mobile terminal 220, or portions thereof, resides on the other node or on a different node in communication with a network.

FIG. 3A is a diagram of a record 301 of a social user profile data structure, according to one embodiment. The social data structure includes multiple records, including at least one record 301 for each user registered with the social service, such as the social content service of the illustrated embodiment. The social record 301 includes a user identifier (ID) field 303, a user name field 305, a user contact addresses field 307, other user information field 309, a user images field 311, and a friends list field 313. In some embodiments, additional fields are included.

While the depicted fields in FIG. 3A, and subsequent diagrams FIG. 3B and FIG. 3C, are shown as integral blocks of data in a particular order in a record in a single structure for purposes of illustration, in other embodiments one or more fields, or portions thereof, are arranged in a different order on one or more records in one or more data structures on one or more nodes connected to a communications network, e.g., network 105. In some other embodiments, one or more depicted fields or portions thereof are omitted.

The user ID field 303 holds data that indicates the registered user of the social content service. The user ID may be expressed in any form from a name, government identifier or, preferably, a database index key into a database record of a social database serving as the social data structure.

The user name field 305 holds data that indicates one or more names for the user, such as a given name, a family name, a user name, a nickname or an alter ego name or screen name, or some combination. One or more portions of this field may be without data (called blank portions or null portions hereinafter). The user contact addresses field 307 holds data that indicates an address to use to contact the user, such as a postal address, an email address, one or more telephone numbers, or an instant messenger service ID, or some combination, with or without one or more blank portions.

The other user information field 309 holds data that indicates other information that may be of interest to the social service, such as age, profession, education level, subscription date, hobbies, sports, favorite sport teams, or favorite genre of content for a social content service, or some combination, with or without one or more blank portions. The user images field 311 holds data that indicates one or more images of the user for display on a webpage or other presentation medium, with or without one or more blank portions. In some embodiments, the field 311 merely holds a pointer to an image file that resides elsewhere in a database or storage medium.

The friends list field 313 holds data that indicates other registered users of the social service or social content service at one or more levels of affinity with the user indicated in field 303. Any method may be used to store the list of friends, including link lists. For users who have not yet identified any friends, field 313 is a null field. In some embodiments a list of contacts for the user re included in record 301, either in the friend list field 313 or a separate field. Thus contacts known to the user, e.g., usersmom@mailservice.com, but not a registered user of the social service, can be listed in the social data record 301.

FIG. 3B is a diagram of a record 321 of a playlist data structure, according to one embodiment. The playlist data structure includes multiple records, including at least one record 321 for each user registered with a content rendering service, such as the social content service of the illustrated embodiment. The playlist record 321 includes a user identifier (ID) field 323, and one or more content ID fields, e.g., content ID field 325a and content ID field 325b, among others, not shown, collectively referenced hereinafter as content ID fields 325. For each different content ID field 325, the record 321 includes a content genre identifier (ID) field (e.g., field 327a and field 327b, among others collectively referenced as field 327), a subjective rating field (e.g., field 329a and field 329b among others collectively referenced as field 329), and a rendering statistics field (e.g., field 331a and field 331b among others collectively referenced as field 331). In some embodiments, additional fields are included.

The user ID field 323 holds data that indicates a registered user of the content rendering service, such as in the user ID field 303 of a social record 301.

The content ID field 325 holds data that indicates particular content that is rendered by the user who is indicated in the user ID field 323. Any method may be used to indicate the content, for example by a index key pointing to the content on a content server, a filename for a file that holds the content, metadata about the content, such as content name and performing artist name, or an index key to a metadata file describing the content in a database of content metadata. The content genre identifier (ID) field 327 holds data that indicates a category or genre to which the content belongs, e.g., rock music or horror movies. Any method may be used to indicate the genre, such as a genre name, genre code, or index key into a database of metadata about genres. In addition to or instead of genre, also other types of information might be included, such as style, mood, or theme.

The subjective rating field 329 holds data that indicates a rating, if any, for the content as given by the user who is indicated in field 323. Any rating may be used, from a simple like/dislike to a scale with multiple degrees of like and dislike. If no rating is provided by the user for the content, then the field is blank or filled with a default value.

The rendering statistics field 331 holds data that indicates how the user who is indicated in field 323 renders the content indicated in the associated content ID field 325. Any statistics may be indicated, such as number of times rendered, percentage of total rendering time, time of most recent rendering, or other objective measures or statistics describing the user's rendering the specific content indicated in the associated content ID field 325. In some embodiments that provide not only playlists but play history, the rendering statistics field 331 or one or more additional fields hold data that indicates each time that the user rendered the specific content.

In various embodiments described in more detail below, user comments about content are inferred from data in associated subjective rating field 329 or rendering statistics field 331, alone or in some combination.

FIG. 3C is a diagram of a record 341 in a comment data structure, according to one embodiment. The comment data structure includes a record 341 for each registered user of a social content service as well as for zero or more other persons with whom registered users communicate and any other entities to which comments will be attributed, such as deities, animals, cartoon characters, musical instruments and other inanimate objects, any one of which is collectively called an entity. The depicted comment record 341 includes an entity identifier (ID) field 343, a comment type preferences field 345, a user image/avatar field 347, a user video clip field 349, first type expressions fields 250, second type expressions field 252, recommended genres field 361, recommended contents in recommended genres field 363, avoided contents in recommended genres field 365, avoided genres field 367, trigger events field 371, and reactions associated with trigger events field 373. The contents of each of these fields are described in more detail below. In some embodiments, one or more additional fields are also included.

The entity ID field 343 holds data that indicates a registered user of the social content service, such as the user ID of a social record 301, if any. In some embodiments, records 341 (and therefore user IDs in field 343) are generated for one or more default persons or celebrity persons or other persons who are not registered users of the social content service; but, from whom comments might be desired by some registered users. Other persons include contacts with whom a registered user communicates, such as one or more email contacts, telephone contacts and instant messenger (IM) contacts. It is anticipated that some celebrities would give permission to use their identity in generating comments in order to promote publicity for themselves or to promote their ideas about content or to collect a fee or for some other reasons.

The comment type preferences field 345 holds data that indicates the user's preference for type of expressions to use in presenting comments, such as degree of negativity or degree of impolite language or other properties of comments presented to the user about content being rendered, or some combination. Other properties that are associated with types in other embodiments include realms of cultural references and language (e.g., Finnish, English, German, etc,), among others. If the user does not provide input for field 345, or the user is not a registered user, then a blank field or default values are held in field 345. Any method may be used to indicate one or more properties of comments, from simple indication of positive or negative (or polite or impolite) to a scale with multiple degrees of positive and negative (or polite and impolite). Impolite negative comments attributed to a friend about content currently being rendered by a user are often viewed as humorous by that user, and thus a comment service that provides the option for such comments will be valued by users. At the same time, other users may be offended by even mildly impolite language, so such users value an option to keep any negative comments about content in polite language. Other users might not want any criticism at all of the content being rendered, and value an option for only positive comments about the content.

Other properties of comments preferred by the user are indicated in field 345 in some embodiments, e.g., a subset of friends or contacts from whom to select comments and one or more celebrities, or categories of celebrities (such as musicians, actors, athletes) from whom to select comments.

The remaining fields in the record 341 are directed to supporting the generation of comments that will be attributed to the entity indicated in field 343 (called herein the commenting entity), when other users render content, such as when one or more of the friends, indicated in field 313 of a registered user who is the commenting entity, render content and the commenting entity is selected to express the comment being presented.

The user image/avatar field 347 holds data that indicates an image to be presented on another user's content player when a comment on that content is attributed to the commenting entity. Any method may be used to indicate this image or avatar, such as image data, data or instructions for generating an avatar and background using a game display module, or a pointer to a file or a library of files, all well known in the art. In some embodiments, the image data may reside on a separate image sharing service, such as SHARE™ on OVI™ by NOKIA™, and the indicating data may be, for example, a uniform resource identifier (URI) to the image at the image sharing service. In some embodiments, the field 347 holds data that indicates how to modify a default avatar, e.g., by dressing a default avatar in garb reflecting the favorite content genre of the commenting entity, such as cowboy clothes for a user who favors country music, black clothes and makeup for a user who favors gothic music or video, 17^{th} century garb for a user who favors classical music. Thus a default avatar and a few dozen garb indictors can represent a wide variety of registered users or celebrities or contacts or other entitites for presentation using a standard avatar visualization module or game display module. In some embodiments, field 347 includes data indicating multiple poses for an avatar, so that an avatar can be presented as if dancing by flipping between two or more poses indicated in field 347. The background may be fixed or may also flip between two or more views in various embodiments.

User video field 349 holds data that indicates a video clip to be presented on another user's content player when a comment on that content is attributed to the commenting entity. User video field 349 is included in some embodiments, e.g., when an actual video is included of the person indicated in field 343, such as speaking or doing a dance.

It is assumed for purposes of illustration that the first type of expressions are polite expressions and the second type of expression are impolite expressions that use rough or raunchy language. In other embodiments different or more types of expressions are included, such as expressions associated with particular age generations, or cultures, or native tongue. In the illustrated embodiment, the first type expressions fields 250 include polite positive expressions field 351 and polite negative expressions field 355; and the second type expressions fields 252 include impolite positive expressions field 353 and impolite negative expressions field 357.

Polite positive expression field 351 holds data that indicates one or more polite positive expressions used by the commenting entity. Similarly, impolite positive expression field 353 holds data that indicates one or more impolite positive expressions used by the commenting entity; polite negative expression field 355 holds data that indicates one or more polite negative expressions used by the commenting entity; and, impolite negative expression field 357 holds data that indicates one or more impolite negative expressions used by the commenting entity. In some embodiments, each entry in these fields is associated with a value that indicates a degree of positive/negative/polite/impolite, or some combination. In some embodiments, some or all of these expressions are generic positive, negative, polite and impolite expressions that are not associated with particular content or genre of content.

It is contemplated that any method may be used to determine these expressions. In various embodiments, the expressions are provided manually by the commenting entity when the commenting entity registers, or indicates comment type preferences, or the expressions are extracted from communications between the commenting entity and others, such as telephone calls, emails, IM messages and text messages, or the expressions are derived from lyrics associated with the favorite content or favorite genre of the commenting entity, or other sources of expression, or some combination thereof. Of the expressions so obtained, a human or automatic analysis process, described below, is employed to pick out expressions that represent judgments and rank or categorize them as positive or negative or neutral or polite or impolite using language semantic analysis known in the art at the time an embodiment is implemented. In some embodiments, the expressions are sorted so that expressions used in communications between the commenting entity and a particular other user are associated with the other user in record 341; and those expressions are then used when the commenting entity's comments are selected for content being rendered by the other user. In some embodiments, the data in these fields 351, 353, 355, 357 indicates audio data in the voice of the commenting entity, either directly or through a pointer to a file that contains the expression in the voice of the commenting entity, or any other means known in the art.

The recommended genres field 361 holds data that indicates one or more genres recommended by the commenting entity. Similarly, recommended contents field 363 holds data that indicates one or more contents recommended by the commenting entity in the recommended genres; avoided contents field 365 holds data that indicates one or more contents disliked by the commenting entity in the recommended genres; and avoided genres field 367 holds data that indicates one or more genres disliked by the commenting entity. In some embodiments, other fields are included, such as recommended contents in genres that are not otherwise recommended, and names of disfavored groups and favored groups. In various embodiments, the data for fields 361, 363, 365 and 367 are based on direct input from the commenting entity, or are inferred from the ranking or rendering statistics associated with the commenting entity, e.g., in fields 329 and 331, respectively, or determined by some other means. In some embodiments, one or more of fields 3671, 363, 365 and 367 are omitted and the indicated information is derived on demand from the playlist data structure.

The trigger events field 371 holds data that indicates an event within content being rendered that triggers a comment from the commenting entity. For example, in various embodiments, the trigger events field 371 holds data indicating a time during content playback, a chord change or refrain of music within the content, or scene change or character appearance in a video or movie content. Any method may be used to obtain this data, e.g., by recording input from a user during the rendering of the content, or detecting a performer or lyric that the commenting entity has indicated in other fields that the commenting entity especially likes or dislikes. The reactions associated with trigger events field 373 (simply called hereinafter reactions field 373) holds data that indicates the commenting entity's reaction to the occurrence of the trigger event. In various embodiments, the data in reactions field 373 indicates a word, sound or extended discourse by the commenting entity on the trigger event. For example, the trigger event is the appearance of actor Mr. A in any video and the reaction is “dreamy;” or the trigger event is the occurrence of a harmonica sound in a particular song and the reaction is “Same old thing we've heard before!”

FIG. 4 is diagram of a comment presentation on a mobile terminal 400, according to one embodiment. The mobile terminal includes a display screen 401, an audio output component 403 (e.g., a speaker or earphone jack), an audio input component 405 (e.g., built in microphone on a cell phone or jack for digital sound cable), an imagery input component 407 (e.g., a digital camera built in to a cell phone), and a manual input component 409 (e.g., mechanical keypad or virtual keys on a touch screen or both). More detail on the inner components to enable these features is described below with reference to FIG. 10.

In the illustrated embodiment, mobile terminal 400 is used to render content, such as a song or video clip. The display screen 401 includes an area that presents a content description field 411, and an area that presents a content progress bar 413 to indicate how much of the content has been rendered. Both these areas are well known in the art. In some embodiments, display screen also includes an area to present video content, also well known in the art.

According to the illustrated embodiment, the screen 401 includes one or more comment areas, including one or more areas presenting: a commenting person avatar 421 (and background, if any) for a selected commenting entity, a commenting entity name field 423, a comments cloud 425, or comment text 427 within comments cloud 425, or some combination. In some embodiments, the commenting person name or comment text or both are made audible through the audio output 403, either by playing a recorded voice or using a text to voice conversion process, well known in the art. In some embodiments, the avatar 421 flips among two or more graphical presentations, in synchronization to the content being rendered, for example to emulate a dance in syncopation with a sound track being played. As an example of particular comment, comment text 427 states “This movie is way too dreary. Play something with more zip, like Action Movie A!” where the italicized words are selected from expression of the commenting entity, e.g., as stored in field 355, field 351 and field 363 of a comment data record 341 for the selected entity.

Unlike other approaches, comments are not provided for all friends who have expressed an opinion about the content; but only for a selected one or more entities, whether they have expressed an explicit comment or a comment can be inferred, e.g., from data in rendering statistics field 331. In many embodiments, the selection is done automatically based at least in part on default or user-provided comment preferences. In some embodiments, the commenting entity is selected from among preferred entities in a round robin approach. In some embodiments, the commenting entity is selected from among the preferred entities by alternating in a predefined way between those who like and those who dislike the content being rendered, as determined from the subjective ranking or rendering statistics or both for the entity.

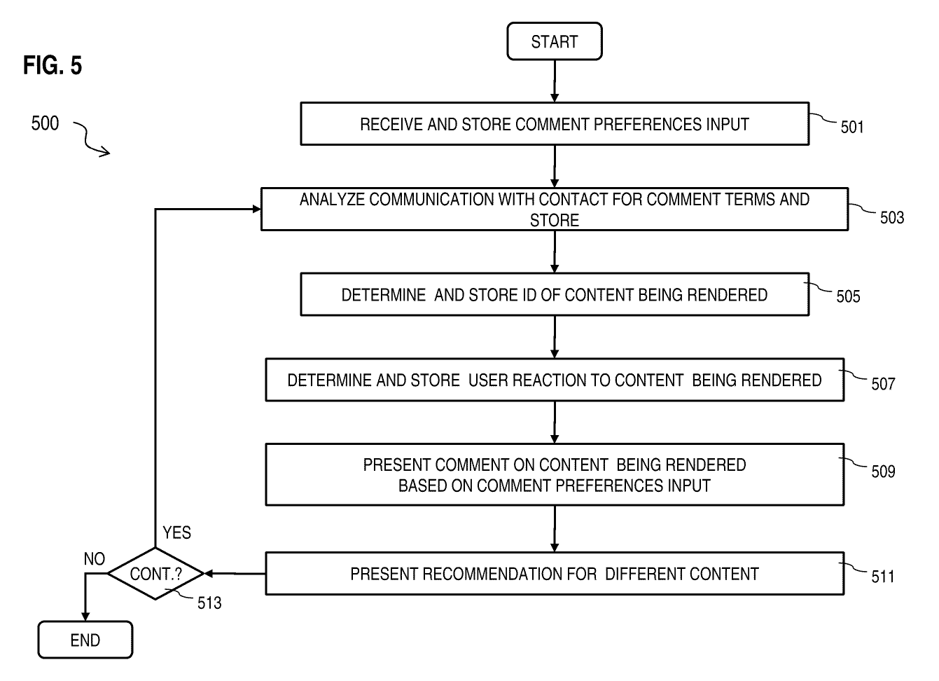

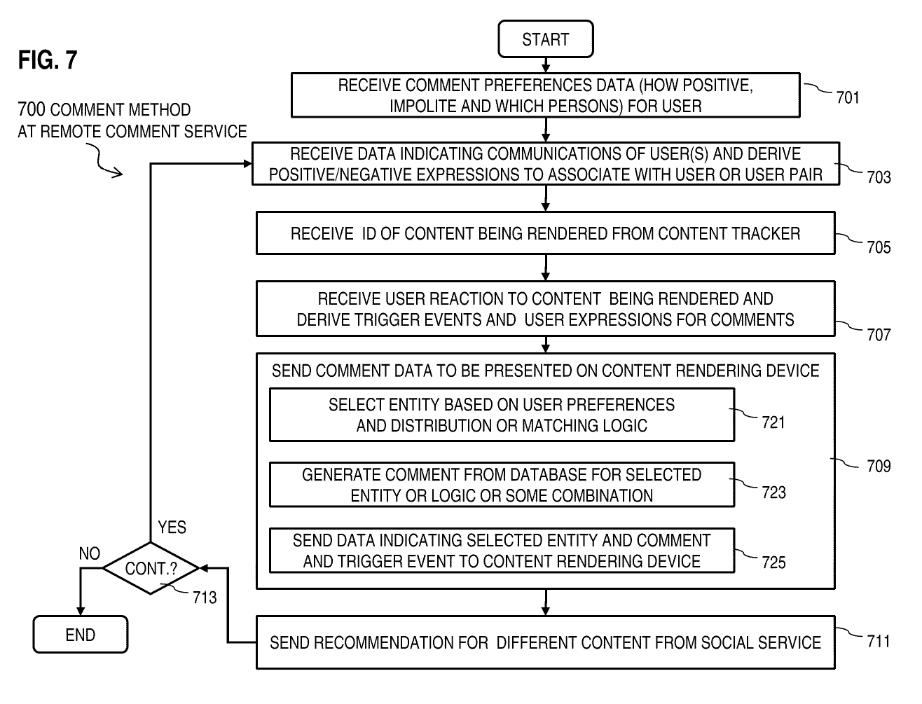

FIG. 5 is a flowchart of a comment process 500, according to one embodiment. The process 500 may be executed on a single node, such as the node rendering the content or a server, or can be divided among two or more nodes. A server is considered to receive data from a user operating a different device by receiving messages sent from a client process on the device operated by the user. Similarly, a server is considered to initiate presentation of data on a different device by sending, to a client process on the different device, data to be presented on that device. Although steps in FIG. 5 and subsequent flow charts FIG. 6 and FIG. 7 are shown in a particular order for purposes of illustration, in other embodiments, one or more steps may be performed in a different order or overlapping in time, in series or in parallel, or one or more steps may be omitted or added, or changed in some combination of ways.

In step 501 comment preferences input is received and stored as comment preferences data. Any method may be used to receive this data. For example, in various embodiments, the data is included as a default value in software instructions, is received as manual input from a network administrator or user on the local or a remote node, is retrieved from a local file or database, or is sent from a different node on the network, either in response to a query or unsolicited, or the data is received using some combination of these methods. For example, the comment preferences input indicates a degree of negativity a particular user can tolerate (e.g., −8 on a scale from very positive=10 to very negative=−10), the degree of impolite language the particular user can tolerate (e.g., 10 on a scale from very raunchy and impolite=10 to very polite=−10), and a range of persons from whom comments are desired by the particular user (e.g., friends within 5 years of the particular user's own age, or celebrities such as musicians with releases in the last ten years). Also during step 501, the particular user selects an image or avatar, or edits a selected one, or both, to represent the user when the particular user is the commenting person for a different user who is rendering content.

In some embodiments, step 501 includes generating or editing an avatar to represent the particular user. The first prototype avatar may be generated automatically, such as in FIG. 1B for user who favors classical music, or FIG. 1C for a user who favors country music. However, if a user is not happy with the avatar that is currently provided, the user can also modify it. The system may support changing the outlook of the avatar by, e.g., providing a set of heads, torsos, feet, clothes, facial expressions, hair, etc. from which the user can select.

In step 503 communications with contacts are analyzed for comment terms, and the comment terms are stored. The contacts include other registered users of the content social network as well as other contacts of the particular user, e.g., on lists of contacts for telephone number and email addresses and IM addresses. For example, spoken terms used during telephone conversations, and written words used in emails, IM, chats and text messages sent via short messaging service (SMS) are captured, sorted by frequency of use, and semantically analyzed for degree of positive expression, negative expression, polite expression and impolite expression, and for names of persons and content or content genres. The terms are associated with the originator of the words and in some embodiments also with the pair of communicating parties. In some embodiments, the other communicating party is added as an entity with content likes and dislikes and comment data, even though that party is not a registered user of the social content service.

In step 505, content requested for rendering, or currently being rendered, by the particular user is determined and stored in the user playlist or play history or both. The current content ID is also passed to the comment module in step 505.

In step 507, the particular user's reaction to the content being rendered is determined and stored. In some embodiments, nothing is done if user reaction to the content is already in the comment record for the user, e.g., in field 373. In some embodiments, if no data is yet in the record for this content, or if sufficient time has passed since the particular user has been queried for a reaction, a prompt is presented on the rendering device to solicit from the particular user a description of the user's reaction. In some embodiments, the user indicates a trigger event in the content being rendered that the reaction is associated with (such as the appearance actor of Mr. A); otherwise the reaction is associated with the start of the content or some other default event, such as the middle of the content, or one minute into the rendering of content.

Step 507 includes other methods of getting expression from the particular user for inclusion in comments to the particular user's contacts. 1) The user could write his own comments as text (e.g. a polite version such as “Oh no! You are listening again to this junk. Wake up dude—Metal rulez!”, and an impolite version) and store them to his profile. 2) The user could select phrases or words from a predefined list and modify them according to subjective wishes. 3) The user could record spoken comments using mobile phone's microphone or upload audio files to the user's comment record. Alternatively, the comments can be video recordings that are used as the avatar. In some embodiments, the comment can be stored with a trigger event that names not just the content (and a particular time within the content, if any), but also the particular contact for whom the comment is intended.

In step 509, a commenting entity is selected and comments are retrieved or derived from the comment data structure record associated with the commenting entity. The selected entity and expressions used in the comment are based at least in part on the preferences input during step 501. If the particular user has no friends or has indicated in the comment preferences that comments are not desired from any friends, then a celebrity in the category indicated in the comment preferences input is selected. In some embodiments, the service searches among all the users of the service for another user who is among the most likely to like or dislike the current music track and select that user to be the commentator. For example, one of the users who has listened to the “Rap 1” song the largest number of times, is selected. Alternatively, if a negative comment is desired, then in such embodiments, the service selects a user from those users that have indicated that they hate the track. If no celebrity category or other user is indicated either, then a default commentator is selected, such as a default entity who uses expressions derived from the content. If the particular user has indicated during step 501 that no comments of any kind are desired, then, based on this input, step 509 presents no comment to the particular user.

Any method may be used to generate the comment from a selected entity, such as extracting whole expressions from the comment database. In some embodiments a template is used with generic expressions inserted into the template from the comment database for the selected commenting entity. For example, a template is stored as “<selected entity name> thinks that only <disparaged group> listen to <avoided genre of selected entity >; and believes that a true <profession of particular user> listens to <recommended genre of selected entity>” where brackets < > enclose the name of a field or portion thereof from the content database 137, such as social data structure 141, playlists data structure 143 or comment data structure 145, alone or in any combination. The comment is generated by replacing the fields between the brackets < > with values in those fields for the selected entity.

In step 511, a recommendation for different content is presented to the particular user on the device rendering the content. For example, a favorite of the entity making comments is presented, e.g., based on values in the recommended contents field 363 of the commenting entity. In other embodiments, the recommended content is produced based on the genre or artist of the particular user's recommended content and content that a content service provider wishes to promote to users.

In step 513, it is determined whether the comment application should continue. If not, then the process ends. Otherwise, the process continues at step 503. In some embodiments the process continues at step 501 so that a user can change the comment preferences.

FIG. 6 is a flowchart of a comment process 600 on a local device, according to one embodiment in which the comment functions are divided between the comment client on the local device and a comment service on a remote host. An advantage of this approach is to move functions that consume substantial resources that are scarce on a local device, such as a mobile terminal, to a more powerful node with substantial resources, which hosts the comment service.

In step 601, a user of the local device is prompted for comment preferences input. Comment preference input is described above with reference to step 501 in FIG. 5. Comment preference input can indicate a desire to not have comments presented or to select or modify an image or avatar to represent the particular user. It is also possible for the particular user to simply ignore the prompts; in which case the particular user is assumed to have selected default values for all comment preferences. Step 601 includes sending data based on the user input to the comment service to store those preferences in a record associated with the particular user.

In step 603, data indicating communications on the local device between the particular user and a contact of the particular user are sent to the remote comment service, e.g., from a comment client 125 or from a communication sampler module 127. In some embodiments, a copy of the entire communication is sent to the comment service. In some embodiments, only the most frequently used words or phrases of the communications are sent to the comment service, alone or along with an identity of the particular user and/or an identity for the contact. The communication types and contacts are described above with reference to step 503 in FIG. 5.

In step 605, the content ID of content currently rendered on the local device is determined, using any method known in the art. The content ID is sent, along with context data such as when and where (e.g. at home, in a car, with friends) and how (e.g., with or without earphones, loudly or softly, while communicating with what contact), to the tracking service on a remote host. In some embodiments, the tracking service then sends data indicating content being rendered to the comment service. In some embodiments, the content ID or context data or both is sent also to the comment service from the comment client local device, either before, during or after the content is rendered.

In step 607, a reaction of the particular user to the content or to a trigger event during the content is determined and sent to the comment service on the remote host. In some embodiments, step 607 includes step 621, in which a prompt is presented to the particular user for that user's rating of the content or for free-form characterization of the content or event during the content, or one or more friends to whom the user's rating or characterization should be sent, alone or in some combination. Conditions for presenting one or more prompts are described in more detail above with reference to step 507 in FIG. 5. The reaction data is used at the comment service on the remote host to update the comment record for the particular user for selection and presentation when the particular user is the selected commenting entity for a different user.

In step 609, comment data is received from the comment service in response to sending the content ID to the tracking service or comment service or both. The comment data is used by the comment client to present a comment on the local device, e.g., as depicted in FIG. 1B, FIG. 1C or FIG. 4. In some embodiments, the comments data is stored locally, e.g., in local files 129, so that the comments can be presented even when the local device is offline. In some embodiments, step 609 includes step 623 or step 625 or both.

In step 623 a dancing graphic is generated from the local data for the avatar of the selected entity. For example two or more views of the avatar are presented in sequence, in synchrony with a dominant rhythm in a sound track included in the content being rendered. In some embodiments the avatar data (including one or more views to emulate dancing) are stored locally so that the avatar can be presented even when the local device (e.g., mobile terminal 120) is offline.

In step 625 a rhythmic or rhyming sound is generated from text produced from the comment service, e.g., using a voice synthesizer. For example, synonyms for a negative expression for the content from the selected entity are searched for a word that rhymes with a word in the sound track of the rendered content in order to produce a rhyming remark as a comment. The rhyming word can be found locally based on the expression received from the comment service, or, in some embodiments, to avoid excess computations on the resource-limited local device, the search is performed on the remote host. In another example, the text received from the comment service is converted by a voice synthesizer, either on the remote host or on the local device in various embodiments, and played in a staccato fashion to match the rhythm of the soundtrack for the content being rendered. Thus a rap song can receive a rap-like spoken comment. A cell phone utilized as mobile terminal 120 is especially adept at presenting synthesized voice that is generated remotely and delivered as a phone call.

In step 611, a recommendation for a different content is received from the remote host, either from the social service or social content service or the selected entity, and is presented on the local device to the particular user by the comment client.

Similar to step 513, described above, in step 613, it is determined whether to continue with the comments on content rendered at the local device.

FIG. 7 is a flowchart of a comment process 700 for a comment service on a remote host, according to one embodiment in which the comment functions are divided between a local device operated by a user and the comment service on a remote host.

In step 701, comment preferences data based on comment preferences input for a particular user is received from the local device, e.g., from the comment client. Comment preference input is described above with reference to step 501 in FIG. 5.

In step 703, data is received indicating communications of the particular user with one or more contacts that might or might not be other registered users of a social content service, e.g., from the communication sampler. During step 703, the comment service process derives full comments about content or generic positive and negative expressions from the data. In some embodiments, semantic analysis is applied to determine a degree of positive or negative meaning to associate with each expression and a degree of impoliteness or raunchiness to associate with each expression. Also, in some embodiments, one or more new entities are derived based on the particular user's communication contacts who are not already registered users or entities associated with records in the comment database. New user IDs and records are added to the comments data structure for these new entities.

In step 707, the content ID of content currently, imminently or recently rendered by the particular user on the local device is received, either directly from the comment client or indirectly by way of the tracking service, such as tracking service 133 on one of the remote hosts 130.

In step 709, a comment is caused to be presented on the local device by determining a comment, based at least in part on the comment preferences for the particular user, and sending data indicating the comment to the comment client on the local device. In the illustrated embodiment, step 709 includes step 721, step 723 and step 725.

In step 721, an entity is selected, which is at least one of a default commentator or a celebrity or a friend or contact of the particular user who is rendering the content. The selection of an entity is based at least in part on the comment preferences data received in step 701. For example, the entity is constrained to be a friend in a range of friends indicated in the preference data or a celebrity in a category of celebrities indicated in the preferences data or a default person if the preferences data indicates the particular user wants no comments from friends or celebrities or if the particular user did not indicate any friends or contacts or celebrity categories. As another example in some embodiments, the entity is selected to be a friend of the user who has most recently consumed to the particular media. In some embodiments, the entity is chosen as some user from the service who has particularly liked or hated the content being rendered. In some embodiments, the entity is selected to be a friend of the user who has consumed the particular media in a similar context as the user is currently, such as in a car, at home, or with friends.

When there are multiple entities from which to select, a subset of one or more entities are selected. An advantage of selecting fewer than all allowed entities is that a more personalized and unique comment can be presented to the particular user, with fewer repetitions. Fewer repetitions mean more surprising comments and more opportunity for the particular user to find the comment entertaining. In some embodiments, the selection is a round robin or random selection of the multiple allowed entities. In some embodiments, the multiple allowed entities are sorted into groups of entities who are more or less negative about a favorite genre or content of the particular user, and selections are made from one group or alternating among several of the groups. In some embodiments, the selection is made from a group of entities who satisfy the degree of negative comments for which the particular user has indicated a desire in the comment preferences data.

In step 723, a comment is generated from the comment database record for the commenting entity. For example, if the content being rendered produces the trigger event for the selected user, the reaction data is used to construct the comment, either directly or indirectly using a template for a triggered event. If the content being rendered does not have a trigger event for the selected user, the comment is generated from the expressions stored for the entity, up to but not exceeding the degree of negativity or impoliteness indicated by the comment preferences of the particular user, either directly or indirectly using a template for a non-triggered event. For example, a comment is generated using the template described above with reference to step 509 in FIG. 5. It is assumed for purposes of illustration that the entity's name is “John”; the entity does not indicate a disparaged group so that a default disparaged group “teenagers” is used; the entity's avoided genre is “heavy metal”; the particular user's profession is “engineer”; and the recommended genre of the entity is “electronica.” Then the template produces the comment: “John thinks that only teenagers listen to heavy metal; and believes that a true engineer listens to electronica.” A less polite version of this comment can be generated by adding impolite adjectives and adverbs to the template or comment. For example, “John thinks that only **** teenagers **** listen to **** heavy metal; and believes that a true **** engineer **** listens to **** electronica” is produced in which the “****” strings are replaced by an impolite negative adjective, impolite negative adverb, impolite negative adjective, impolite positive adjective, impolite positive adverb, and impolite positive adjective, respectively, from the entity's comment record. In some embodiments, context information collected from the rendering clients is utilized in generating the comment. For example, when a user is driving a car, the comment from an entity might be “When on the road, I like to listen to <artist 1> instead”. Here, artist 1 is a recommended artist by the entity.

In some embodiments, step 723 includes converting one or more words of the template to different words with similar meanings that more closely match the content being rendered, such as by using words from the lyrics of a song or words in a script for the content, or by rhyming with such words. In some embodiments, text is converted to voice, including adapting the voice to the rhythm of the content, such as to a soundtrack of video content; and, then the voice is transmitted to the local device for presentation to the particular user. A cell phone serving as mobile terminal 120 is particularly adept at transmitting and rendering voice data.

In step 725, data indicating the selected entity and the comment and any trigger event are sent to the local device that renders the content. The comment client on the local device then presents the comment, e.g., as a talking or texting avatar depicted in FIG. 1B or FIG. 1C or FIG. 4.

In step 711, a recommendation for different content can be received from the social service and transmitted to the local device.

As in steps 513 and 613, described above, in step 713, it is determined whether to continue with the comments on content being rendered.

The processes described herein for tracking and commenting on content playback may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

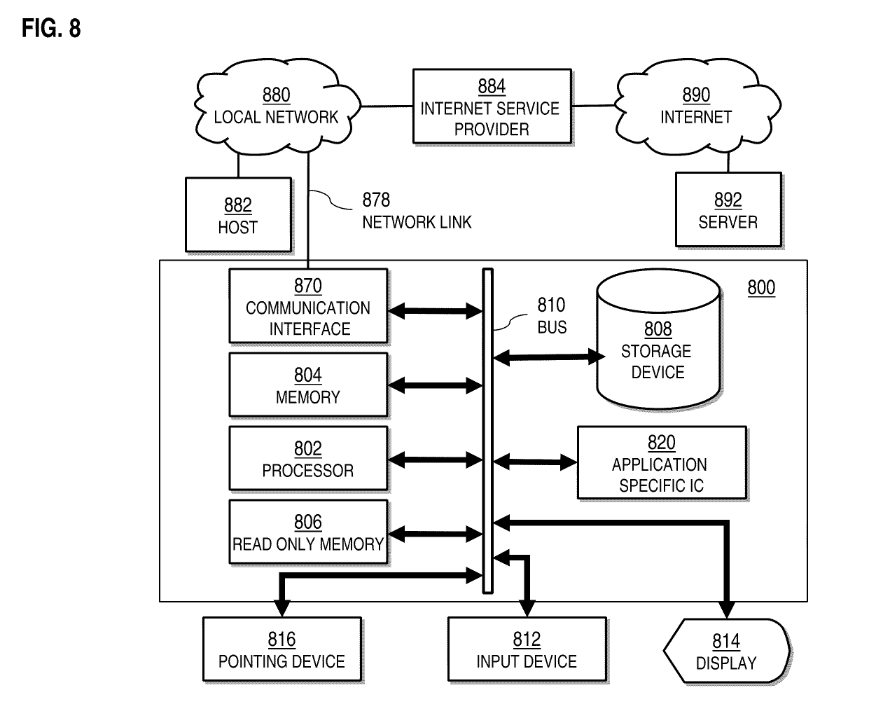

FIG. 8 illustrates a computer system 800 upon which an embodiment of the invention may be implemented. Computer system 800 includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890. A computer called a server host 892 connected to the Internet hosts a process that provides a service in response to information received over the Internet. For example, server host 892 hosts a process that provides information representing video data for presentation at display 814.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

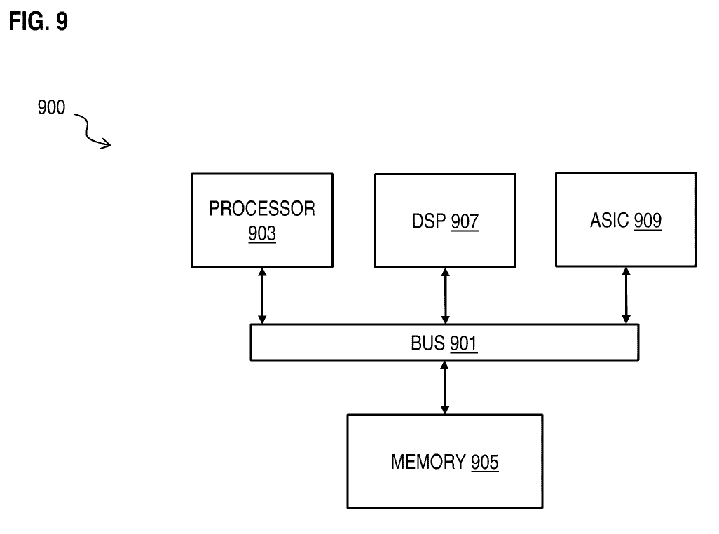

FIG. 9 illustrates a chip set 900 upon which an embodiment of the invention may be implemented. Chip set 900 is programmed to carry out the inventive functions described herein and includes, for instance, the processor and memory components described with respect to FIG. 9 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-word signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein. The memory 905 also stores the data associated with or generated by the execution of the inventive steps.

FIG. 10 is a diagram of example components of a mobile station (e.g., handset) capable of operating in the system of FIG. 1A, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003-which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-readable storage medium carrying one or more sequences of one or more instructions which, when executed by one or more processors, cause an apparatus to perform at least the following:
determining a preference of a user for types of expressions presented as comments;
determining content received for rendering on the apparatus or another apparatus of the user; and
automatically initiating presentation on the apparatus of a comment about the content, based on the preference of the user, in response to the content being received for rendering.

2. A computer-readable storage medium of claim 1, wherein initiating presentation of the comment further comprises:
determining an entity to which the comment is attributed; and
initiating presentation on the apparatus of an identifier for the entity when the content is being rendered to represent the entity as providing the comment.

3. A computer-readable storage medium of claim 2, wherein determining the entity further comprises selecting the entity based at least in part on a content taste of the user and a content taste of the entity as indicated in data structures associated with each.

4. A computer-readable storage medium of claim 2, wherein the entity is one of a default commentator, a celebrity, another user of a network service, or a member of a contact group for the user.

5. A computer-readable storage medium of claim 2, wherein initiating presentation on the apparatus of an identifier for the entity further comprises initiating presentation on the apparatus of an avatar of the entity.

6. A computer-readable storage medium of claim 2, wherein initiating presentation of the comment further comprises initiating generation of the comment automatically using terms stored in a data structure associated with the entity.

7. A computer-readable storage medium of claim 6, wherein the terms stored in the data structure associated with the entity are input manually.

8. A computer-readable storage medium of claim 6, wherein the entity is a contact of the user and the terms stored in the data structure associated with the entity are derived automatically from communications of the contact.

9. A computer-readable storage medium of claim 6, wherein:
the terms stored in the data structure associated with the entity are associated with a trigger event associated with rendering the content; and
initiating presentation on the apparatus of a comment about the content is triggered upon occurrence of the trigger event.

10. A computer-readable storage medium of claim 1, wherein the apparatus is caused to further perform:
receiving comment input from the user, wherein the comment input indicates the user's reaction to the content being rendered; and
initiating storage in a data structure associated with the user of expressions based on the comment input in association with at least one of the content or a category of content to which the content belongs.

11. A computer-readable storage medium of claim 1, wherein the apparatus is caused to further perform:
receiving communication data that indicates expressions used in communications with the user; and
initiating storage in a data structure associated with the user of expressions based on the communication data.

12. A computer-readable storage medium of claim 11, wherein initiating storage of expressions based on the communication data further comprises indicating a type of each of the expressions.

13. A computer-readable storage medium of claim 1, wherein determining the preference of the user further comprises determining the user's preference for at least one of degree of negativity or degree of impolite language in comments presented to the user.

14. A computer-readable storage medium of claim 1, wherein initiating presentation on the apparatus of the comment about the content further comprises initiating presentation of the comment in a style of the content.

15. An apparatus comprising a processor and a memory storing executable instructions that (1) as part of execution or as a result of execution at least or (2) as both part of execution and as a result of execution at least cause the apparatus to perform at least the following:
determine a preference of a user for types of expressions presented as comments;
determine content received for rendering on the apparatus or another apparatus of the user; and
automatically initiate presentation on the apparatus of a comment about the content, based on the preference of the user, in response to the content being received for rendering.

16. A system including the apparatus of claim 15, the system further comprising a comment server apparatus configured to: determine the content by receiving from the apparatus data indicating the content; and, initiate presentation of the comment on the apparatus by initiating sending the comment to the apparatus that is configured to present the comment.

17. An apparatus of claim 15, wherein to initiate presentation of the comment further comprises:
determine an entity to which the comment is attributed; and
initiate presentation on the apparatus of an identifier for the entity when the content is being rendered to represent the entity as providing the comment.

18. An apparatus of claim 17, wherein to initiate presentation on the apparatus of an identifier for the entity further comprises to initiate presentation on the apparatus of an avatar of the entity.

19. An apparatus of claim 17, wherein to initiate presentation of the comment further comprises to initiate generation of the comment automatically using terms stored in a data structure associated with the entity.

20. A method comprising:
providing access to receive, from a device, data indicating content being rendered on the device in response to input from a user and data indicating the user's preference for types of expressions presented as comments; and
in response to receiving the data indicating the content, transferring a comment based on the user's preference to be presented on the device.
